(19) United States
(12) Patent Application Publication
(10) Pub. No.: US 2025/0156576 A1
(43) Pub. Date: May 15, 2025

(54) SYSTEM WITH PRIVACY-PRESERVING NEURAL GRAPH DATABASES AND METHOD FOR USING THE SAME

(71) Applicant: The Hong Kong University of Science and Technology, Hong Kong (CN)

(72) Inventors: Yangqiu SONG, Hong Kong (CN); Qi HU, Hong Kong (CN); Haoran LI, Hong Kong (CN); Jiaxin BAI, Hong Kong (CN)

(21) Appl. No.: 18/938,326

(22) Filed: Nov. 6, 2024

Related U.S. Application Data
(60) Provisional application No. 63/597,697, filed on Nov. 10, 2023.

(51) Int. Cl. G06F 21/62; G06F 16/245; G06F 16/901

(52) U.S. Cl. CPC G06F 21/6227; G06F 16/245; G06F 16/9024

(57) ABSTRACT

A privacy-preserving neural graph database system is provided for receiving a user query and delivering an answer. The system includes: a user query input receiver, a graph builder module, a query encoder model, a privacy risk identifier, a score calculator engine, and an answer output module. The input receiver captures queries in structured language. The graph builder constructs a computational graph as a directed acyclic graph using queries, where edges represent operations on entities and attributes. The query encoder converts the queries into a vector format. The answer retriever module receives the vector format of the query and retrieves candidate answer sets to the queries. The privacy risk identifier classifies the results into public and privacy answer sets and flags potential privacy breaches. The score calculator evaluates these sets with loss functions. The answer output module selects the final answer based on these evaluations.

### TECHNICAL FIELD

The present invention generally relates to a system with a privacy-preserving neural graph database (P-NGDB) and a method using the same, thereby alleviating risks of privacy leakage in Neural graph databases (NGDBs).

### BACKGROUND

Graph databases (Graph DBs) play a crucial role in storing, organizing, and retrieving structured relational information and are widely applied in downstream applications, such as recommender systems and fraud detection. Unfortunately, traditional graph databases often suffer from the limitation of graph incompleteness, which is a prevalent issue in real-world knowledge graphs, like Freebase. This incompleteness leads to the exclusion of relevant results, as the graph database may not capture all the necessary relationships and connections between entities through traversal.

To address these drawbacks, neural graph databases (NGDBs) extend the concept of Graph DBs by combining the flexibility of graph data models with the computational capabilities of neural networks, enabling efficient representation, storage, and analysis of interconnected data. NGDBs provide unified storage for diverse entities in an embedding space, empowering expressive and intelligent querying, inference, and knowledge discovery through graph-based neural network techniques. This capability, known as complex query answering (CQA), aims to identify answers that satisfy given logical expressions.

Logical expressions are often defined in predicate logic forms with relation projection operations, existential quantifiers (∃), logical conjunctions (Λ), disjunctions (∨), and more. The logical forms of q include terms like Win(V, Turing Award) and logical operators like conjunction (Λ), representing queries such as “find where the Turing Award winner who was born in 1960 lived.”

Query encoding methods are commonly used in Complex Query Answering (CQA), involving the parameterization of entities, relations, and logical operators, encoding both queries and entities into the same embedding space simultaneously, and retrieving answers according to the similarity between the query embedding and entity embedding. For example, methods like GQE and query2box encode queries as vectors and hyper-rectangles, respectively.

While NGDBs have demonstrated significant achievements in various domains, they do face unique privacy challenges in comparison to traditional graph DBs. One notable risk arises from their generalization ability. Although generalization efficiently handles incomplete knowledge graphs and enriches the retrieval information, it also enables attackers to infer sensitive information from NGDBs by leveraging the composition of multiple complex queries.

FIG. 1 shows the structure of NGDBs. NGDBs can retrieve answers given complex logical queries on incomplete graphs. However, the privacy problem arises due to the storage of graph information in embedding space and the presence of a query engine that facilitates complex logical query answering. To illustrate the issue, consider an example where an attacker attempts to infer private information about Hinton's living place in the NGDBs. Direct querying privacy can be easily detected by privacy risk detection; however, attackers can leverage the combination of multiple queries to retrieve desired privacy.

More specifically, as shown in FIG. 1, the living place information about an individual, in this case, Hinton as an example, is considered private. Even though Hinton's residence is omitted during the construction of the knowledge graph, or if direct privacy queries are restricted, a malicious attacker can still infer this sensitive information without directly querying Hinton's living place. For example, by querying NGDBs with where Turing Award winners born before 1950 and after 1940 lived, where LeCun's collaborator lived, etc. The intersection of these queries still presents a significant likelihood of exposing the living place of Turing Award winner Hinton.

Graph privacy has consistently been a significant concern in the field of graph research. Multiple studies demonstrate the vulnerability of graph neural networks to various privacy leakage issues. For instance, graph embeddings are vulnerable to attribute inference attacks, link prediction attacks, etc. and various protection methods are proposed. However, these works focus on graph representation learning and have the assumption that the graph embeddings can be reached by the attackers which are not typical scenarios in NGDBs. NGDBs often provide CQA service and do not publish the learned embeddings, and attackers only can infer privacy using thoughtfully designed queries. Furthermore, these works solely study node classification and link prediction problems, leaving the query answering privacy in NGDBs unexplored.

Therefore, since the privacy concerns related to query answering in NGDBs remain unexplored, there is a need for improvement in neural graph databases to enhance graph privacy while delivering high-quality public answers to queries.

### SUMMARY OF INVENTION

It is an objective of the present invention to provide a system and a method to address the aforementioned issues in the prior arts.

The potential privacy risks of neural graph databases (NGDBs) are exposed through formal definition and evaluation. Privacy protection objectives are introduced to the existing NGDBs, categorizing the answers of knowledge graph complex queries into private and public domains. To safeguard private information within the knowledge graph, NGDBs should strive to maintain high-quality retrieval of non-private answers for queries while intentionally obfuscating the private-threatening answers to innocuous yet private queries. For example, the answer sets of queries proposed by privacy attackers are obfuscated, and attackers will face greater challenges in predicting private information, thereby effectively safeguarding the privacy of NGDBs. Additionally, a corresponding benchmark is created on three datasets (e.g., Freebase, YAGO, and DBpedia) to evaluate the performance of complex query answering (CQA) on public query answers and the protection of private information.

To alleviate the privacy leakage problem in NGDBs, Privacy-preserving Neural Graph Databases (P-NGDBs) are proposed as one of solutions in the present invention. P-NGDBs divide the information in graph databases into private and public parts and categorize the answers to complex queries based on the associated privacy risks, depending on whether or not they involve sensitive information. P-NGDBs can provide answers with different levels of precision in response to queries with varying privacy risks. Adversarial techniques are introduced during the training stage of P-NGDBs to generate indistinguishable answers when queried with private information, thereby enhancing the difficulty of inferring privacy through complex private queries. In the present invention, the major contributions are summarized as follows:

(1) The provided solution represents a pioneering effort in investigating privacy leakage issues of complex queries in NGDBs and offers formal definitions for privacy protection in this domain.

(2) A benchmark is proposed for the simultaneous evaluation of CQA ability and privacy protection in NGDBs, based on three public datasets.

(3) P-NGDB, a privacy protection framework for safeguarding privacy in NGDBs, is introduced. Extensive experiments conducted on three datasets demonstrate its ability to effectively preserve high information retrieval performance while ensuring privacy protection.

In accordance with a first aspect of the present invention, a system using a privacy-preserving neural graph database is provided. The system is for receiving a query from a user and giving an answer to the user in response to the query. The system includes a user query input receiver, a graph builder module, a query encoder model, an answer retriever module, a privacy risk identifier, a score calculator engine, and an answer output module. The user query input receiver is for serving as a user interface to receive a structured query language as a query from a user. The graph builder module is configured to receive the query from the user query input receiver and configured to construct a computational graph for converting the query into a directed acyclic graph, where edges represent operations on sets of entities and attributes. The query encoder model is configured to receive the query graph from the graph builder module for processing the query, in which the query encoder model is configured to convert the query into a vector format. The answer retriever module is configured to receive the vector format of the query from the query encoder model and retrieve candidate answer sets to the queries. Information output by the answer retriever module denotes candidate answer sets of entities or values retrieved by the embedding based search. The privacy risk identifier is configured to receive the information output by the answer retriever module and determine whether the answer sets pose any privacy risks, check for sensitive information, and flag queries that lead to privacy breaches, in which the privacy risk identifier is further configured to classify the answer sets from the computational graph into a public answer set and a privacy answer set. The score calculator engine is configured to receive the public answer set and the privacy answer set and calculate a score of each candidate answer by computing probability of the public answer set and the privacy answer set using corresponding loss functions. A low threshold is assigned to a loss function for the public answer set by the score calculator engine, requiring a loss function calculation result for the public answer set to be lower than the threshold. A high threshold is given to a loss function for the privacy answer set by the score calculator engine, requiring a loss function calculation result for the privacy answer set to be higher than the threshold. The answer output module is configured to reference results of the loss functions in combination with the threshold values to select a final answer for the original query.

In accordance with a second aspect of the present invention, a method using a privacy-preserving neural graph database is provided. The method is for receiving a query from a user and giving an answer to the user in response to the query. The method includes steps as follows: receiving, by a user query input receiver, a structured query language as a query from a user; constructing, by a graph builder module, a computational graph for converting the query into a directed acyclic graph, where edges represent operations on sets of entities and attributes, wherein information output by the graph builder module denotes answer sets of entities or values retrieved by the computational graph; encoding, by a query encoder model, the query graph into a vector format; retrieving, by an answer retriever module, the vector format of the query into a set of candidate answers; determining, by a privacy risk identifier, whether the answer sets pose any privacy risks, check for sensitive information, and flag queries that lead to privacy breaches; classifying, by the privacy risk identifier, the answer sets from the computational graph into a public answer set and a privacy answer set; calculating, by a score calculator engine, a score of each candidate answer by computing probability of the public answer set and the privacy answer set using corresponding loss functions, wherein a low threshold is assigned to a loss function for the public answer set by the score calculator engine, requiring a loss function calculation result for the public answer set to be lower than the threshold, and wherein a high threshold is given to a loss function for the privacy answer set by the score calculator engine, requiring a loss function calculation result for the privacy answer set to be higher than the threshold; and referencing, by an answer output module, results of the loss functions in combination with the threshold values to select a final answer for the original query.

### BRIEF DESCRIPTION OF DRAWINGS

Embodiments of the invention are described in more details hereinafter with reference to the drawings, in which:

FIG. 1 shows a structure of a neural graph database (NGDB);

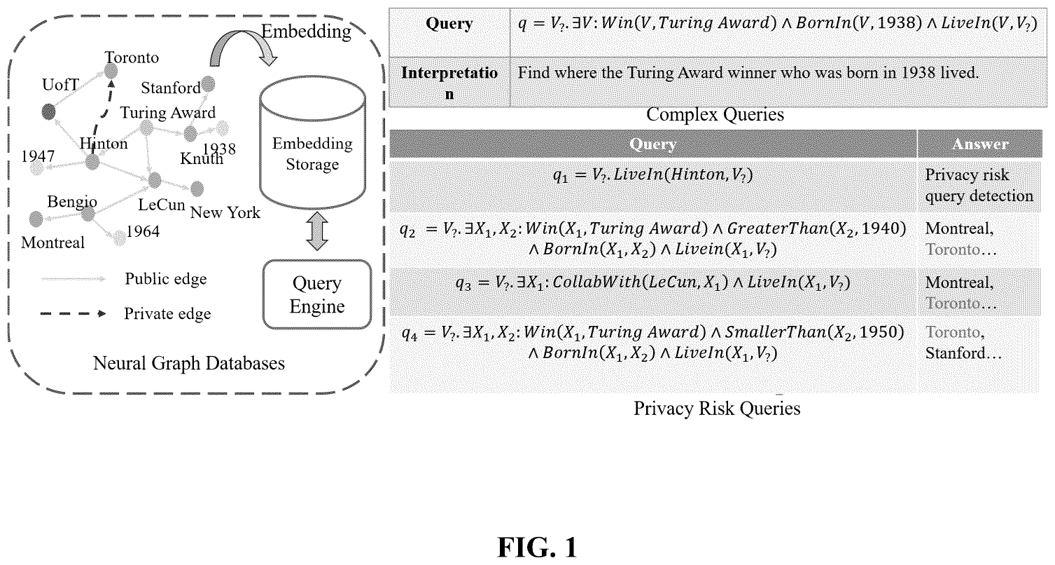

FIG. 2 shows an example of query demonstrating the retrieved privacy-threatening query answers;

FIG. 3 shows an example of privacy-threatening answer sets computation in projection, intersection, and union according to some embodiments of the present invention;

FIG. 4 provides Table 1 for comprehensive comparison;

FIG. 5 shows eight general query types;

FIG. 6 provides Table 2 for comprehensive comparison;

FIG. 7 provides Table 3 for comprehensive comparison;

FIG. 8 provides Table 4 for comprehensive comparison;

FIG. 9 shows an evaluation results of GQE with various privacy coefficients β; and

FIG. 10 depicts a schematic diagram of an architecture of a system using a privacy-preserving neural graph database (P-NGDB) according to some embodiments of the present invention.

### DETAILED DESCRIPTION OF THE INVENTION

In the following description, systems and methods using a privacy-preserving neural graph database (P-NGDB) and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

In the present invention, based on the privacy protection in graph embeddings, a system using P-NGDB is provided to alleviate the risks of privacy leakage in neural graph databases (NGDBs). Adversarial training techniques are introduced in the training stage to force the NGDBs to generate indistinguishable answers when queried with private information, enhancing the difficulty of inferring sensitive information through combinations of multiple innocuous queries. Extensive experiment results on three datasets show that P-NGDB can effectively protect private information in the graph database.

In this regard, there are several related studies/works for complex query answering (CQA) and graph privacy, stated as follows.

### Technical Background-Complex Query Answering

One essential function of neural graph databases is to answer complex structured logical queries according to the data stored in the NGDBs, namely CQA. Query embedding is one of the prevalent methods for complex query answering because of its effectiveness and efficiency.

These methods for query embedding utilize diverse structures to represent complex logical queries and effectively model queries across various scopes. Some methods encode queries into different geometric representations: the GQE model encodes queries as vectors in embedding space, Query2box encodes them as hyper-rectangle embeddings, and HypeE encodes them as hyperbolic embeddings to support disjunction logical operators. Query2Particle and ConE support negation operators using multiple vector embeddings and cone embeddings, respectively. NRN is proposed for encoding numerical values. Additionally, some methods use probabilistic structures to encode logic queries: BetaE, Gamma, and PERM propose using Beta, Gamma, and Gaussian distributions, respectively, to encode logical knowledge graph queries. Meanwhile, neural structures are employed to encode complex queries: BiQE, SQE, and QE-GNN utilize transformers, sequential encoders, and message-passing graph neural networks, respectively. Query Decomposition proposes decomposing complex queries, and LMPNN suggests using one-hop message passing on query graphs to conduct CQA.

While complex query answering has been widely studied in past works, the privacy problem in NGDBs is overlooked. With the development of the representation ability in NGDBs, the issue of privacy leakage has become increasingly critical. There are some works showing that graph representation learning is vulnerable to various privacy attacks. Some works show that membership inference attacks can be applied to identify the existence of training examples. Model extraction attacks and link stealing attacks try to infer information about the graph representation model and original graph link, respectively. However, these works assume that attackers have complete access to the graph representation models. In NGDBs, however, sensitive information can be leaked during the query stage, presenting a different privacy challenge. In the present invention, the provided disclosure explores the issue of privacy leakage in NGDBs and presents a benchmark for comprehensive evaluation.

### Technical Background-Graph Privacy

Various privacy protection methods have been proposed to preserve privacy in graph representation models. Anonymization techniques are applied in graphs to reduce the probability of individual and link privacy leakage. Graph summarization aims to publish a set of anonymous graphs with private information removed. Learning-based methods are proposed with the development of graph representation learning, regard graph representation learning as the combination of two sub-tasks: primary objective learning and privacy preservation, and use adversarial training to remove the sensitive information while maintaining performance in the original tasks. Meanwhile, some methods disentangle the sensitive information from the primary learning objectives. Additionally, differential privacy introduces noise into representation models and provides privacy guarantees for the individual privacy of the datasets. Though noise introduced by differential privacy protects models from privacy leakage, it can also impact the performance of the original tasks significantly. Federated learning utilizes differential privacy and encryption to prevent the transmission of participants' raw data and is widely applied in distributed graph representation learning. However, federated learning cannot be applied to protect intrinsic private information in the representation models.

While there are various graph privacy preservation methods, they only focus on simple node-level or edge-level privacy protection. However, the privacy risks associated with neural graph databases during complex query answering tasks have not received sufficient research attention. The development of CQA models introduces additional risks of privacy leakage in NGDBs that attackers can infer sensitive information with multiple compositional queries. The proposed P-NGDB in the present invention can effectively reduce the privacy leakage risks of malicious queries.

The issues regarding preliminary and problem formulation are described below.

The privacy problem in a multi-relational knowledge graph with numerical attributes is considered. A knowledge graph is denoted as [symbol] =( [symbol] , [symbol] , [symbol] , [symbol] ), where [symbol] represents the set of vertices corresponding to entities in the knowledge graph. [symbol] denotes the set of relations, where r∈R is a binary function defined as r: [symbol] × [symbol] →{0, 1} describing the relation between entities in the knowledge graph. Here, r(u, v)=1 indicates that there is a relation r between entities u and v and r(u, v)=0 otherwise. [symbol] denotes the set of attributes, which can be divided into private attributes and public attributes: [symbol] = [symbol] ₚᵣᵢᵥₐₜₑ∪ [symbol] _{public}, where a∈ [symbol] is a binary function defined as a: [symbol] × [symbol] →{0, 1} describing the numerical attribute of entities, where a(u, x)=1 denotes that the entity u has the attribute a with value x∈ [symbol] and a(u, x)=0 otherwise. Besides, there are f(x₁, x₂): [symbol] × [symbol] →{0, 1} to denote the relation between numerical values. To prevent privacy leakage, the private attributes of entities [symbol] ₚᵣᵢᵥₐₜₑ cannot be exposed and should be protected from inferences.

The complex query, a key task of NGDBs, can be defined in existential positive first-order logic form, consisting of various types of logical expressions such as existential quantifiers (∃), logical conjunctions (Λ), and disjunctions (∨). In the logical expression, there is a unique variable V_{?} in each logic query that denotes the query target. Variables V₁, . . . , Vₖ and numerical variables X₁, . . . , Xₗ, denote existential quantified entities in a complex query. Additionally, anchor entities Vₐ and values Xₐ are provided with specific content in a query. The complex query aims to identify the target entity V_{?} such that there exist V₁, . . . , Vₖ∈ [symbol] and X₁, . . . , Xₗ∈ [symbol] in the knowledge graph that can satisfy the given logical expressions. The complex query expression can be represented in disjunctive normal form (DNF) as follows:

$$q [ {V}_{?} ] = {V}_{?} . {V}_{1} , … , {V}_{k} , {X}_{1} , … , {X}_{l} : {c}_{1} ⋁ {c}_{2} ⋁ … ⋁ {c}_{n} ; {c}_{i} = {e}_{i , 1} ∧ {e}_{i , 2} ∧ … ∧ {e}_{i , m}$$

The atomic logic expression e_{i,j} can represent r(V, V′), which denotes the relation r between entities r and V′; a(V, X), which denotes the attribute a of entities V with value X; or f(X, X′), which denotes the relation between numerical attributes. cᵢ represents the conjunction of several atomic logic expressions e_{i,j}. The symbols V, V′, X, are either anchor entities, values, existentially quantified variables, or numerical variables.

Regarding problem formulation, it is to suppose that there is a graph [symbol] =( [symbol] , [symbol] , [symbol] , [symbol] ), where part of the entities' attributes are regarded as private information, with [symbol] = [symbol] ₚᵣᵢᵥₐₜₑ∪ [symbol] _{public}, where aₚ∈ [symbol] denotes that the entity u has the sensitive attribute aₚ with value x if aₚ(u, x)=1. Due to the variation in privacy requirements, an attribute can be handled differently for various entities. NGDBs store the graph in embedding space and can be queried with arbitrary complex logical queries. Due to the generalization ability of NGDBs, attackers can easily infer sensitive attributes [symbol] ₚᵣᵢᵥₐₜₑ utilizing complex queries. To protect private information, NGDBs should retrieve obfuscated answers when queried with privacy risks while preserving high accuracy in querying public information.

In the present invention, a program for innocuous yet private query is provided. As there is sensitive information in the neural graph databases, some specified complex queries can be utilized by attackers to infer privacy, which is defined as “Innocuous yet Private (IP) queries.” Some answers to these queries can only be inferred under the involvement of private information, which is a risk to privacy and should not be retrieved by the NGDBs. In response to this requirement, the architecture and mechanism for the program that handles innocuous yet private queries are described below.

In the following description, “Query q” refers to the content input by a user into the proposed system, which may consist of a structured query language statement. This query serves as a request for specific information or data retrieval from the neural graph database, and it is processed through various components to determine and return the most relevant answers while ensuring privacy preservation.

The architecture of the system at includes two parts, “Computation Graph” and “Privacy Threatening Query Answers.”

### Computation Graph:

The query q can be parsed into a computational graph as a directed acyclic graph, which consists of various types of directed edges that represent operators over sets of entities and attributes. Operations/operator in the computational graph includes Projection, Intersection, and Union.

(1) Projection: Projection has various types. Given a set of entities S, a relation between entities r∈ [symbol] , an attribute type a, a set of values S⊂ [symbol] , projection describes the entities or values can be achieved under specified relation and attribute types. For example, attribute projection is denoted as P_a(S)={x∈N|v∈S, a(v, x)=1} describing the values that can be achieved under the attribute type a by any of the entities in S. Furthermore, relational projection Pᵣ(S), reverse attribute projection Pₐ⁻¹ (S) and numerical projection P_{f}(S) are proposed, and all these projections are denoted as P(S).

(2) Intersection: Given a set of entity or value sets S₁, S₂, . . . , Sₙ, this logic operator computes the intersection of those sets as ∩ᵢ₌₁ⁿSᵢ.

(3) Union: Given a set of entity or value sets S₁, S₂, . . . , Sₙ, the operator computes the union of ∪ᵢ₌₁ⁿSᵢ.

### Privacy Threatening Query Answers:

After a complex query is parsed into the computational graph G, and M=G(S) denotes the answer set of entities or values retrieved by the computational graph. In this regard, the M retrieved by the complex queries is divided as private answer set Mₚᵣᵢᵥₐₜₑ and non-private answer set M_{public} based on whether the answer has to be inferred under the involvement of private information.

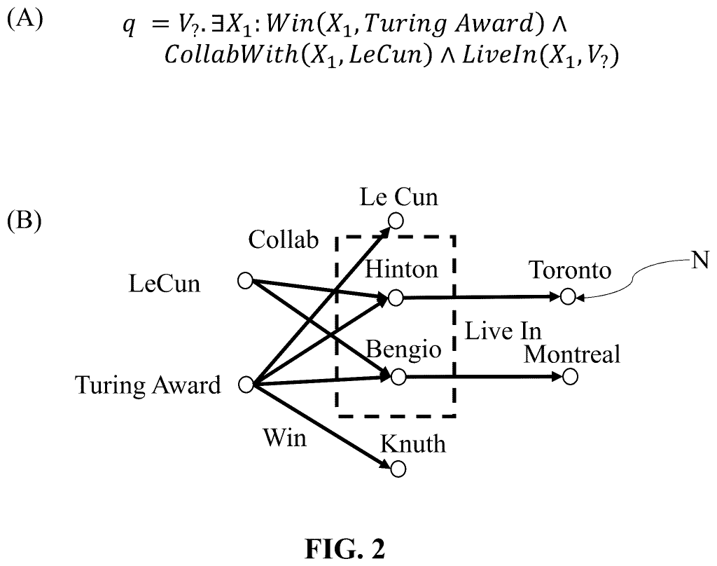

FIG. 2 shows an example of query demonstrating the retrieved privacy-threatening query answers. In the illustration, the node N denotes privacy risks. In the part (A) of FIG. 2, the logic knowledge graph query involves privacy information. In the part (B) of FIG. 2, there is an example of a complex query in the knowledge graph, Toronto is regarded as a privacy-threatening answer as it has to be inferred by sensitive information.

Query in the part (A) of FIG. 2 retrieves answers from the knowledge graph, Toronto is regarded as privacy-threatening answers because LiveIn(Hinton, Toronto)∈ [symbol] .

The operation/operator for Projection: A projection operator's output will be regarded as private if the operation is applied to infer private attributes. Assume that M=P(S) and input S=Sₚᵣᵢᵥₐₜₑ∪S_{public}; P(S)=P(Sₚᵣᵢᵥₐₜₑ)∪P(S_{public}). Without loss of generalization, the discussion is made for the formal definition of projection private answer set Mₚᵣᵢᵥₐₜₑ in two scenarios.

For the projection on public inputs: Mₚᵣᵢᵥₐₜₑ={m|∃v∈S:m∈MΛP(v, m)∈ [symbol] ₚᵣᵢᵥₐₜₑΛP(u, m)≠P(v, m), ∀u∈S/{v}}.

For the projection on private inputs: Mₚᵣᵢᵥₐₜₑ=P(S_{Private}).

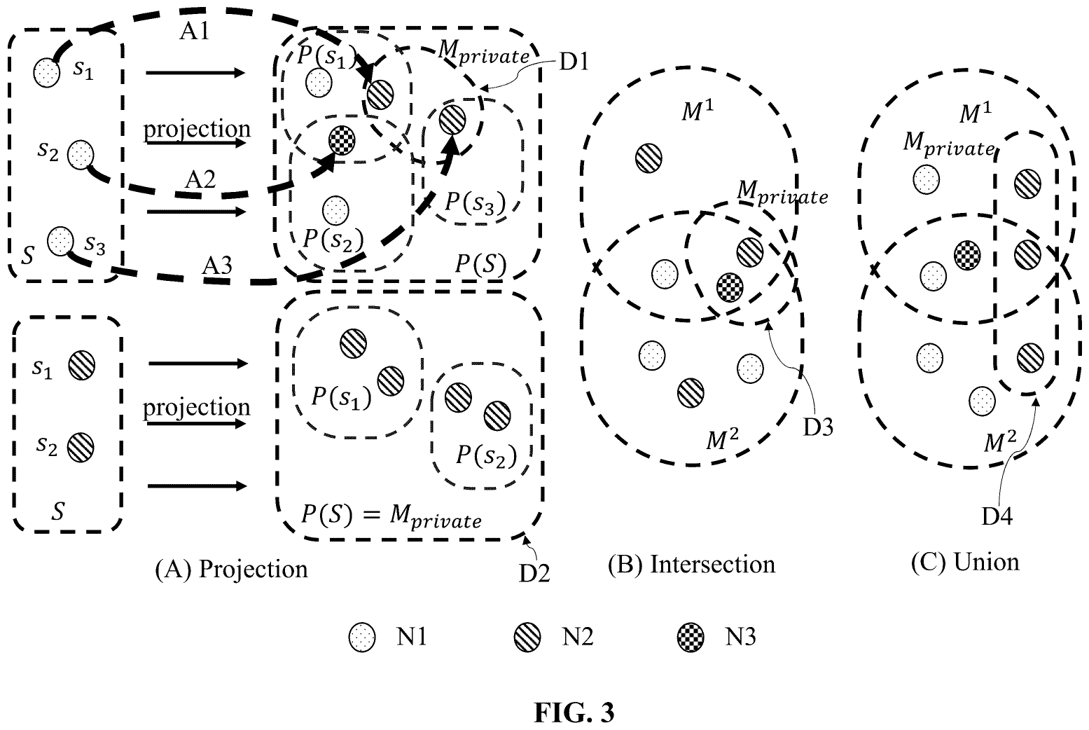

FIG. 3 shows an example of privacy-threatening answer sets computation in projection, intersection, and union according to some embodiments of the present invention. In the illustration, nodes N1 denote non-private answers, nodes N2 denote privacy-threatening answers, and nodes N3 denote different privacy risks in subsets. Dashed-line arrows A1, A2, and A3 denote privacy projection. The ranges demarcated by the dashed lines D1, D2, D3, and D4 denote privacy-threatening answer sets. As shown in the part (A) in FIG. 3, all the nodes N2 within the answer sets can solely be deduced from private attribute links and are classified as query answers posing privacy risks. On the other hand, all the nodes N3, while accessible through private projection, can also be inferred from public components, thereby carrying lower privacy risks.

The operation/operator for Intersection: An intersection operator's output will be regarded as private if the answer belongs to any of the private answer sets. Given a set of answer sets M¹, M², . . . , Mⁿ, where each answer set Mⁱ=Mₚᵣᵢᵥₐₜₑⁱ∪M_{public}ⁱ, after intersection operator, Mₚᵣᵢᵥₐₜₑ=∩ᵢ₌₁ⁿMⁱ−∩ᵢ₌₁ⁿM_{public}ⁱ. As shown in the part (B) in FIG. 3, the node N3 is categorized as a privacy-threatening answer because it denotes the existence in the answer subsets.

The operation/operator for Union: A union operator's output will be regarded as private if the answer is the element that belongs to the private answer set of computational subgraphs while not belonging to public answer sets. Given a set of answer sets M¹, M², . . . , Mⁿ, Mₚᵣᵢᵥₐₜₑ=∪ᵢ₌₁ⁿMₚᵣᵢᵥₐₜₑⁱ−∪ᵢ₌₁ⁿM_{public}ⁱ. As shown in the part (C) in FIG. 3, all the nodes N2 within the answer sets can only be inferred from private attribute links and are classified as privacy-threatening answers.

Next, a privacy-preserving neural graph database according to some embodiments of the present invention is provided. The privacy-preserving neural graph database is presented for protecting sensitive information in knowledge graphs while preserving high-quality complex query answering performance. There are two optimization goals set for P-NGDBs: preserve the accuracy of retrieving non-private answers and obfuscate the privacy threatening answers.

### Encoding Representation for the Privacy-Preserving Neural Graph Database:

The query encoding methods encode queries to embedding space and compare the similarity with the entities or attributes for answer retrieval, the encoding process can be represented as:

$$q = {f}_{g} ( Query ) ,$$

where f_{g} is the query encoding methods parameterized by θ_{g}, and q∈R^{d} represents the query embedding for simplicity. Given a query, the queries is iteratively computed based on the sub-query embeddings and logical operators. The assumed is that the encoding process in step i, the subquery embedding is qᵢ. The logical operators projection, intersection, and union can be denoted as:

$${q}_{i + 1} = {f}_{p} ( {q}_{i} , r ) , r ∈ ℛ ⋃ 𝒜 ,$$

$${q}_{i + 1} = {f}_{i} ( {q}_{i}^{1} , … , {q}_{i}^{n} ) ,$$

$${q}_{i + 1} = {f}_{u} ( {q}_{i}^{1} , … , {q}_{i}^{n} ) ,$$

where fₚ, fᵢ, and fᵤ denote the parameterized projection, intersection, and union operators, respectively. After query encoding, the score for every candidate is computed based on the query encoding and entity (attribute) embeddings. Finally, the normalized probability can be calculated using the Softmax function as follows:

$$p ( q , v ) = {e}^{s ( q , {e}_{v} )} / {\sum }_{u ∈ 𝒞} {e}^{s ( q , {e}_{u} )} ,$$

where s is the scoring function, like similarity, distance, etc., and [symbol] is the candidate set.

### Learning Objective for the Privacy-Preserving Neural Graph Database:

In privacy-preserving neural graph databases, there are two learning objectives: given a query, P-NGDBs should accurately retrieve non-private answers and obfuscate the private answers. For public retrieval, given query embedding q, the loss function can be expressed as:

$${L}_{u} = - \frac{1}{N} log log p ( q , v ) ,$$

where [symbol] is the public answer set for the given query.

While for privacy protection, the learning objective is antithetical. Instead of retrieving correct answers, the objective is to provide obfuscated answers to address privacy concerns. Therefore, for private answers, given query embedding q, the objective can be expressed as:

$$= arg {min}_{{θ}_{g}} log p ( q , v ) ,$$

where [symbol] is the private risk answer set for a given query.

In one embodiment, the query can be decomposed into sub-queries and logical operators. For intersection and union, the logical operators do not generate new privacy invasive answers; while for projection, the answer can be private if the projection is involvement of private information. Therefore, the projection operators can be directly optimized to safeguard sensitive information. The privacy protection learning objective can be expressed as:

$${L}_{p} = \frac{1}{\vert {𝒜}_{private} \vert} {\sum }_{r ( u , v ) ∈ {𝒜}_{private}} log p ( {f}_{p} ( {e}_{v} , r ) , u )$$

The provided solution of the present invention aims to reach the two objectives simultaneously and the final learning objective function can be expressed as:

$$L = {L}_{u} + β {L}_{p} ,$$

where β is the privacy coefficient controlling the protection strength in P-NGDBs, larger β denotes stronger protection.

Experiments are provided to prove the performance of the system for the P-NGDB. To evaluate the privacy leakage problem in NGDBs and the protection ability of the proposed P-NGDBs, a benchmark is constructed on three real-world datasets for evaluation of P-NGDB's performance based on that.

### Experiments-Datasets

Benchmarks are created based on the numerical complex query datasets, which are constructed on FB15K-numerical, DB15K-numerical, and YAGO15K-numerica, three publicly available knowledge graph datasets. In each knowledge graph, vertices describe entities and attributes, while edges describe entity relations, entity attributes, and numerical relations.

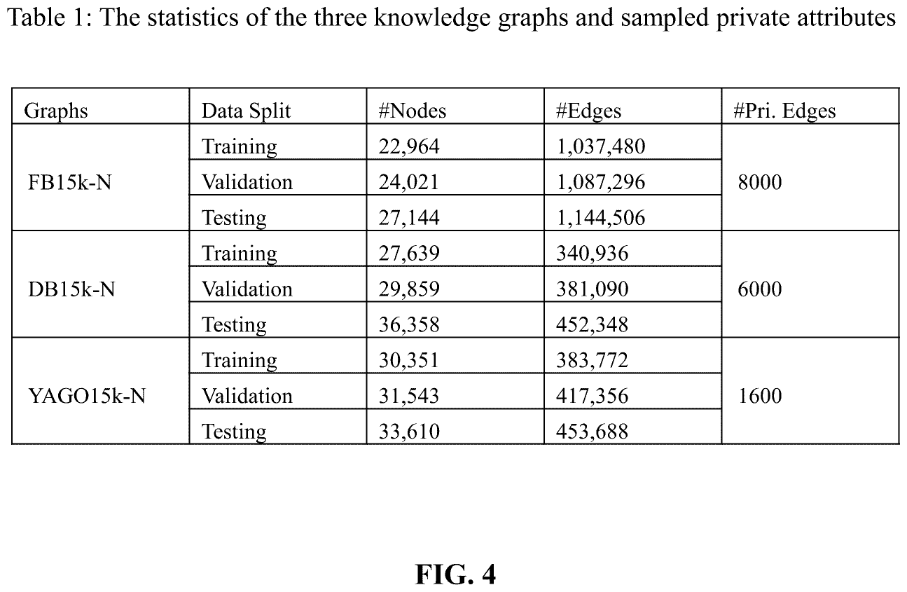

First, a set of edges denoting entities' attributes is randomly selected as privacy information. Then, the remaining edges are divided with a ratio of 8:1:1 to construct training, validation, and testing edge sets, respectively. The training graph [symbol] , validation graph [symbol] , and testing graph [symbol] are constructed on training edges, training+validation edges, and training+validation+testing edges, respectively. The detailed statistics of the three knowledge graphs are shown in Table 1 of FIG. 4, where “#Nodes” represents the number of entities and attributes, “#Edges” represents the number of relation triples and attribute triples, and “#Pri. Edges” represents the number of attribute triples considered private.

### Experiments-Benchmark Construction

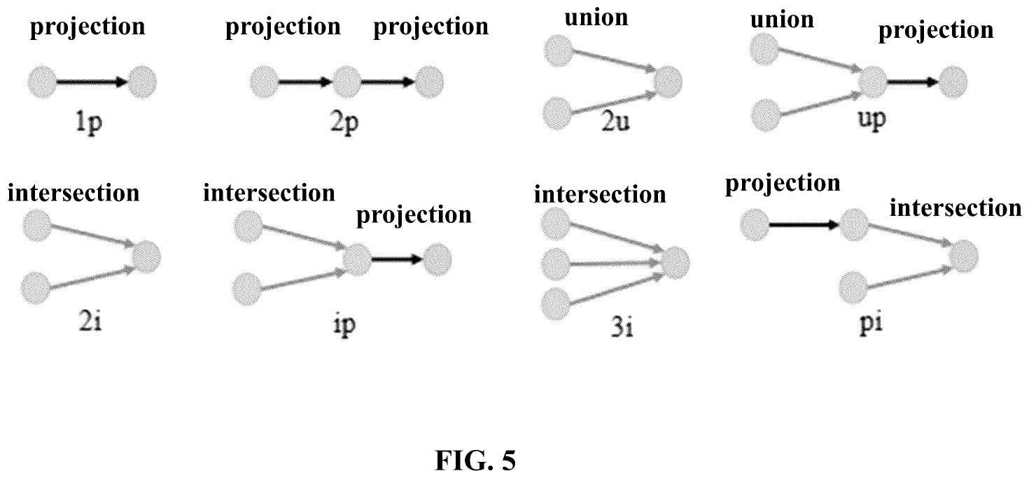

The complex query answering performance is evaluated on the following eight general query types with abbreviations: 1p, 2p, 2i, 3i, ip, ip, 2u, and up, as shown in FIG. 5.

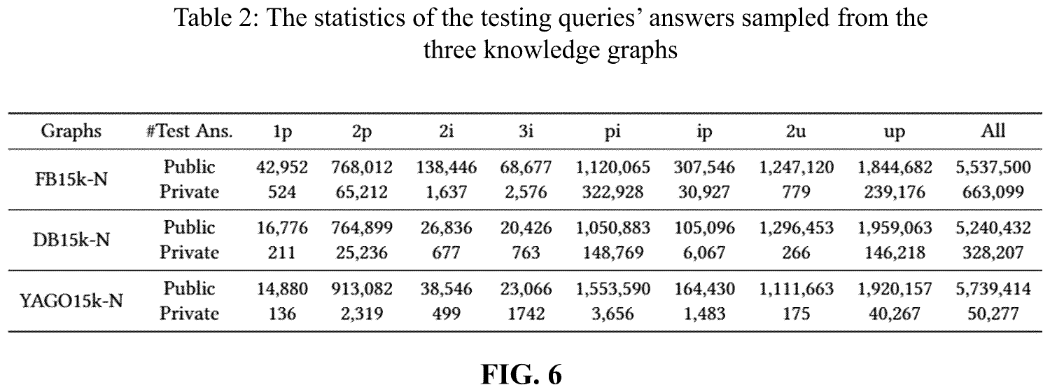

FIG. 5 shows eight general query types. Those arrows denote projection, intersection, and union operators respectively. For each general query type, each edge represents either a projection or a logical operator, and each node represents either a set of entities or numerical values. The sampling method is used to randomly sample complex queries from knowledge graphs. Training, validation, and testing queries are randomly sampled from the previously constructed graphs, respectively. For the training queries, corresponding training answers are searched on the training graph. For the validation queries, those queries that have different answers on the validation graph from the answers on the training graph are used to evaluate the generalization ability. For the testing queries, a graph search is conducted on the testing graph with private edges to identify testing answers, and the answers are split into private and public sets according to the definition of privacy risk query answers as-afore discussed. A statistical analysis of the number of privacy risk answers for different types of complex queries across three knowledge graphs is conducted, and the statistics are shown in Table 2 of FIG. 6.

### Experiments-Experimental Setup

Regarding baselines, the proposed P-NGDBs can be applied to various complex query encoding methods to provide privacy protections.

Three commonly used complex query encoding methods are selected for comparing the performance with and without P-NGDB's protection.
GQE: the graph query encoding model encodes a complex query into a vector in embedding space;
Q2B: the graph query encoding model encodes a complex query into a hyper-rectangle embedding space.
Q2P: the graph query encoding model encodes a complex query into an embedding space with multiple vectors.

The assumption is that there are no privacy protection methods in NGDBs. Therefore, the comparation for the methods is with noise disturbance which is similar to differential privacy, a commonly employed technique in database queries that introduces randomness to answers through the addition of noise.

Regarding evaluation metrics, the evaluation consists of two distinct parts: reasoning performance evaluation and privacy protection evaluation. In performance evaluation, the generalization capability of models is evaluated by calculating the rankings of answers that cannot be directly retrieved from an observed knowledge graph. Given a testing query q, the training, validation, and public testing answers are denoted as Mtrain, Mval, and Mtest, respectively. The quality of retrieved answers are evaluated using Hit ratio (HR) and Mean reciprocal rank (MRR). HR@K metric evaluates the accuracy of retrieval by measuring the percentage of correct hits among the top K retrieved items. The MRR metric evaluates the performance of a ranking model by computing the average reciprocal rank of the first relevant item in a ranked list of results. The metric can be defined as:

$$Metric ( q ) = \frac{1}{\vert Mtest / Mval \vert} {\sum }_{v ∈ Mtest / Mval} m ( rank ( v ) ) ,$$

where m(r)=1[r≤K] if the metric is HR@K and

$$m ( r ) = \frac{1}{r}$$

if the metric is MRR. Higher values denote better reasoning performance.

In the privacy protection evaluation, the rankings metric of privacy-threatening answers is computed, as these answers cannot be inferred from the observed graphs, with smaller values indicating stronger protection. All models are trained using the training queries and private attributes, and hyper-parameters are tuned using the validation queries. The evaluation is then conducted on the testing queries, which includes the assessment of public answers for performance and private answers for privacy. The experimental results are reported separately for testing public and private queries respectively.

Regarding parameter setting, hyper-parameters for the base query encoding methods are first tuned on the validation queries. The same parameters are used for NGDBs to ensure a fair comparison. The privacy penalty coefficient (B) is adjusted for the three datasets respectively to achieve a balance between utility and privacy for convenient illustration. For noise disturbance privacy protection, the noise strength is adjusted to ensure that the results are comparable to those of NGDBs, maintaining similar performance on public query answers.

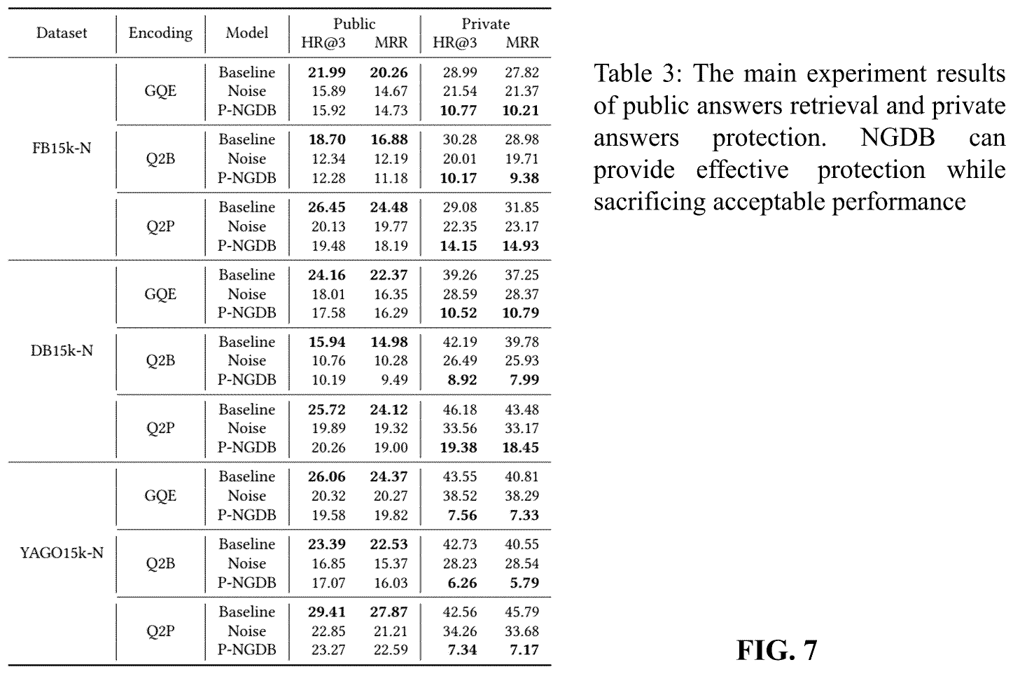

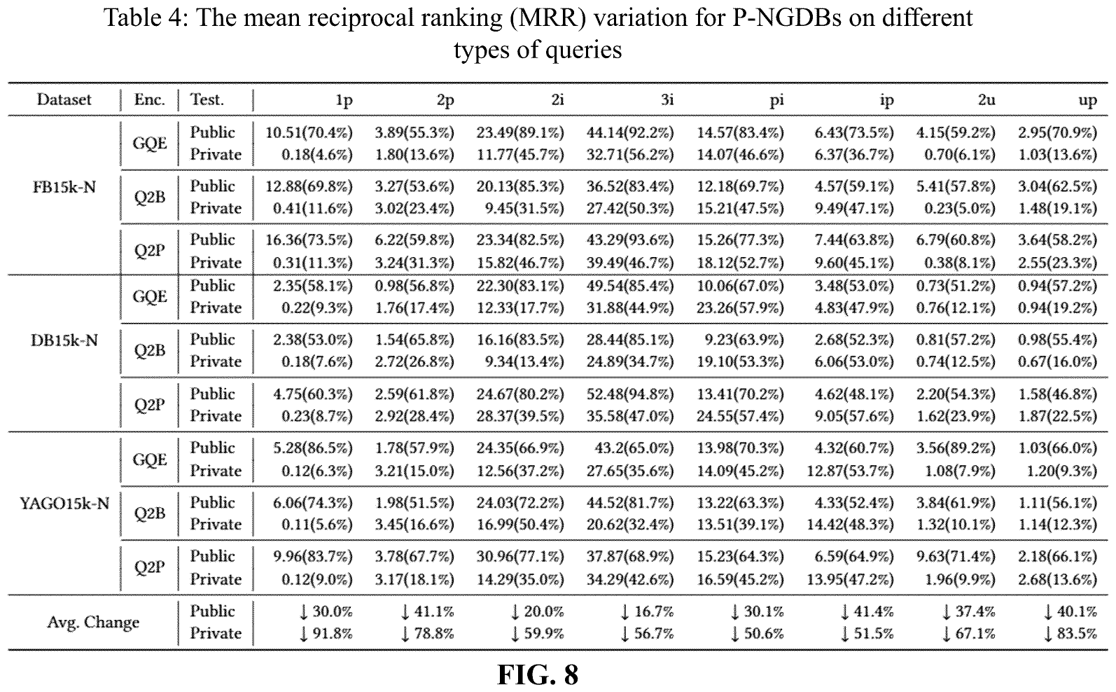

Regarding performance evaluation, the P-NGDB is applied to three different query encoding methods: GQE, Q2B, and Q2P, and the query answering performance with and without P-NGDB's protection is compared. The experiment results are summarized in Table 3 of FIG. 7 and Table 4 of FIG. 8.

Table 3 reports the averaged results in HR@3 and MRR, where a higher value on public answer sets indicates better reasoning ability, while a smaller value on private answer sets indicates stronger protection. The results demonstrate that, without protection, the base encoding methods all suffer from privacy leakage problems if sensitive information is present in the knowledge graph. The proposed P-NGDB effectively protects private information with only a slight loss in complex query answering ability. For example, in FB15K-N, GQE retrieves public answers with 21.99 HR@3 and private answers with 28.99 HR@3 without privacy protection, whereas with P-NGDB's protection, GQE retrieves public answers with 15.92 HR@3 and private answers with 10.77 HR@3. The private answers are protected with a 62.9% decrease in HR@3, while there is a 27.4% decrease in HR@3 for public answers. Compared to noise disturbance protection, the method accurately protects sensitive information, resulting in a much lower loss of performance than noise disturbance.

In Table 4, the MRR results of P-NGDBs on various query types are shown, with the percentages in parentheses representing the performance of the P-NGDB-protected model relative to the performance of the encoding model without protection. The evaluation is conducted on public and private answers respectively to assess privacy protection. From the comparison of MRR variation on public and private answers, it can be observed that P-NGDB provides protection across all query types. Additionally, by comparing the average change across these query types, it is evident that P-NGDB exhibits different levels of protection for various query types. For projection and union operations, the MRR of protected models on private answers is significantly reduced, indicating stronger protection. For the intersection operator, the preservation provided by P-NGDBs is as effective as the protection for other operators.

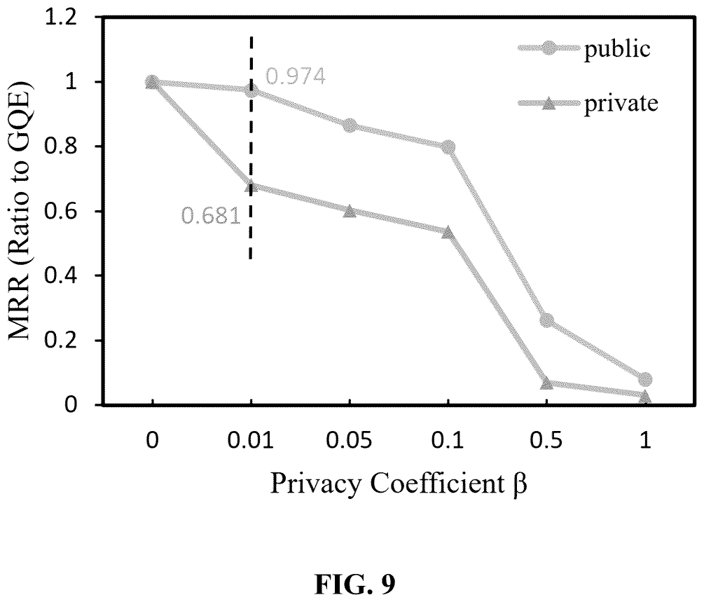

Regarding sensitivity study, the privacy protection needs can vary across different knowledge graphs. The impact of the privacy penalty coefficient β is evaluated, where a larger β provides stronger privacy protection. The value of β is selected from {0.01, 0.05, 0.1, 0.5, 1}, and the retrieval accuracy of public and private answers is assessed respectively. The retrieval performance of GQE on the FB15K-N dataset is evaluated, and the change in MRR under each β, compared to the unprotected GQE model, is depicted in FIG. 9, which shows the evaluation results of GQE with various privacy coefficients β on FB15K-N. The results indicate that the penalty can effectively control the level of privacy protection, and to meet higher privacy needs, P-NGDBs must accept a greater utility loss. Additionally, the flexible adjustment of the privacy coefficient allows P-NGDBs to adapt to various scenarios with different privacy requirements.

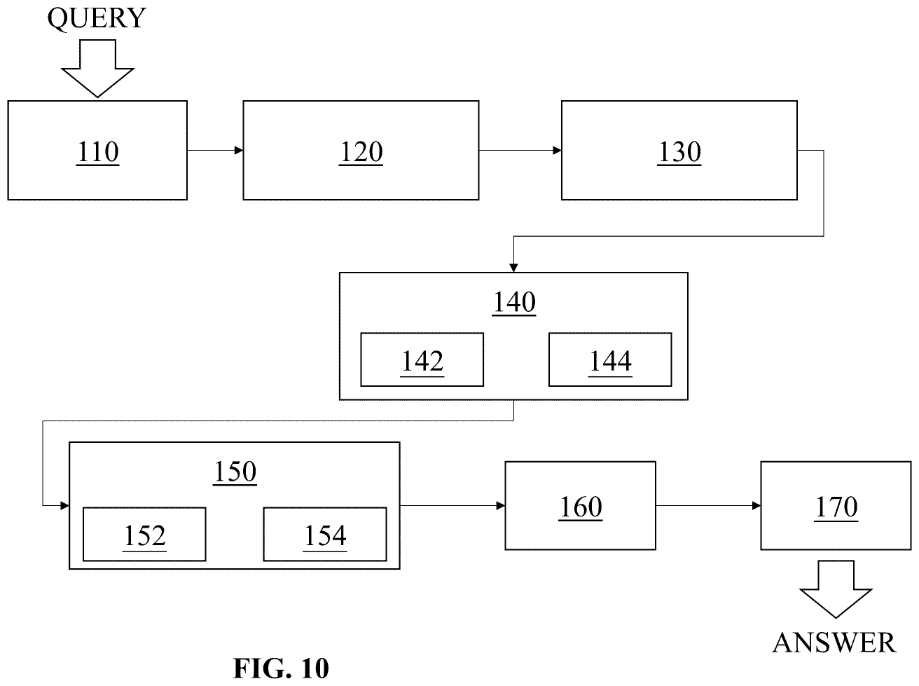

The proposed system can be physically set up in a hardware device. FIG. 10 depicts a schematic diagram of an architecture of a system 100 using a P-NGDB according to some embodiments of the present invention.

The system 100 can serve as a privacy-preserving neural graph database (i.e., P-NGDB) for receiving a query from a user and then the privacy-preserving neural graph database gives an answer to the user in response to the query. The system 100 includes a user query input receiver 110, a graph builder module 120, a query encoder model 130, an answer retriever module 140, a privacy risk identifier 150, a score calculator engine 160, and an answer output module 170.

The user query input receiver 110 can serve as a user interface. For example, a user enters a query into the system 100 via the user query input receiver 110, which could be a natural language question or a structured query language.

The input query is forwarded to the graph builder module 120 by the user query input receiver 110. The graph builder module 120 is responsible for constructing a computational graph, converting the query into a directed acyclic graph, where edges represent operations on sets of entities and attributes.

The query encoder model 130 receives the computation query graph from the graph builder module 120, and then the computation query graph is processed by the query encoder model 130. The query encoder model 130 is configured to convert the query graph (i.e., the computation query graph) into a vector format that the components of the system 100 can handle (i.e., being readable for the components of the system 100). Through an encoding process provided by the query encoder model 130, the query is transformed into a vector representation (e.g., a numerical representation of the query).

The answer retrieval module 140 receives the vector/numerical representation of the query from the query encoder model 130, which called a query vector in this stage. The answer retrieval module 140 further retrieves candidate answer sets using the query vector processed by the query encoder model 130. In one embodiment, the system 100 further includes an embedding transformer module configured to encode the query vector into an embedding space. The outcome of the embedding transformer module is called an optimized query vector. In one embodiment, the answer retriever module 140 includes a projection engine 142 and an operator setting model 144 for the computational query graph.

Within the computational graph, the projection engine 142 performs various types of projection operations, such as attribute projection and relation projection. This process by the projection engine 142 involves extracting relevant entities or numerical values from the entity set and processing them according to the specified relationships and attribute types.

Within the answer retrieval, the operator setting model 144 is responsible for handling set operations, such as intersections and unions. The operator setting model 144 sets operations on multiple sets of entities or numerical values to obtain the result set. For example, the operator setting model 144 can provide an intersection operation/operator on multiple sets of entities or numerical values, identifying the common elements shared among all the sets; and the operator setting model 144 can provide a union operation/operator on multiple sets of entities or numerical values, identifying all the elements across all the sets.

After processing the query vector through the answer retrieval module 140, information output by the answer retrieval module 140 denotes answer sets of entities or values retrieved by the computational graph.

The answer sets are passed to the privacy risk identifier 150. The privacy risk identifier 150 is configured to determine whether the answer sets pose any privacy risks, check for sensitive information, and flag queries that might lead to privacy breaches. In one embodiment, the privacy risk identifier 150 includes a privacy threatening answers classification model 152 that collaborates in classifying the answer sets from the computational graph into a public answer set (i.e., a non-privacy answer set) and a privacy answer set, based on whether the answer sets have to be inferred under the involvement of private information.

The privacy answer set consists of answers that require private information to be derived, while the public answer set (i.e., a non-privacy answer set) does not contain such information. When a projection operation result provided by the projection engine 142 involves private attributes, the resulting answers are marked as privacy answers by the privacy risk identifier 150 using the privacy threatening answers classification model 152. Similarly, the results of intersection operations provided by the operator setting model 144 are considered privacy answers by the privacy risk identifier 150 using the privacy threatening answers classification model 152 if they belong to the privacy answer set, even when derived from multiple answer sets. For union operation results provided by the operator setting model 144, the results are considered privacy answers if they include elements belonging to the privacy answer set while not belonging to public answer sets.

In one embodiment, the privacy risk identifier 150 includes a privacy evaluator model 154 configured to evaluate whether the privacy answer set contains any privacy answer with lower privacy risk. Specifically, within the privacy answer set, if an answer is accessible through private projection but it is also inferred from public components by using an intersection or union operator/operation, this answer is determined being carrying lower privacy risks.

Then, the public answer set (i.e., a non-privacy answer set) and the privacy answer set are fed to the score calculator engine 160 from the privacy risk identifier 150. The score calculator engine 160 is configured to calculate a score of each candidate answer by computing the probability of the result sets using corresponding loss functions. In one embodiment, the objectives for computation in the privacy answer set and the non-privacy answer set are antithetical.

The loss function for computation with respect to the public answer set (i.e., a non-privacy answer set) applies the public answer set for the given query as a computation factor/parameter. The public retrieval goal is to ensure that the system 100 can accurately retrieve public/non-private answers, with the loss function used to measure the retrieval accuracy of public answers. The loss function for the privacy answer set uses the private risk answer set for the given query as a computation factor/parameter. The privacy protection goal is to obfuscate private answers to prevent the leakage of private information, so the loss function is used to optimize the output information to effectively obfuscate private answers.

In one embodiment, relative threshold values can be set for these two loss functions by the score calculator engine 160. For example, a low threshold is assigned to the loss function for the public answer set (i.e., a non-privacy answer set), requiring the loss function calculation result for the public answer set (i.e., a non-privacy answer set) to be lower than the threshold. In contrast, a high threshold is given to the loss function for the privacy answer set, requiring the loss function calculation result for the privacy answer set to be higher than the threshold. This approach is advantageous for preserving high accuracy in querying public information while effectively obfuscating private answers based on privacy protection.

The answer output module 170 is configured to reference the results of the loss functions and consider the threshold values to select the final answer. In one embodiment, using algorithms, AI models, or machine learning models, the answer output module 170 can pick the most suitable answer or answers from those that have been privacy-protected, filtered for sensitive information, and scored. The algorithms, AI models, or machine learning models in the system 100 are well-trained. In one embodiment, adversarial techniques are introduced during the training stage of P-NGDBs to generate indistinguishable or obfuscated answers when queried with private information, thereby making it more difficult to infer privacy through complex private queries while still accurately retrieving non-private answers.

Therefore, the system with P-NGDBs can provide answers with varying levels of precision in response to queries with different privacy risks. This approach simplifies the operational processes for privacy protection while reducing computational power consumption. As a result, the process speeds up computation and maximizes efficiency, all while maintaining strict privacy protections.

As discussed above, in the present disclosure, the privacy problem in neural graph databases is proposed, demonstrating that sensitive information can be inferred by attackers through specified queries. It is noted that some query answers can leak privacy information, referred to as privacy risk answers. To systematically evaluate this problem, a benchmark dataset is constructed based on FB15k-N, YAGO15k-N, and DB15k-N. A new framework is proposed to protect the privacy of the knowledge graph from attackers' malicious queries. Experimental results on the benchmark show that the proposed model (i.e., P-NGDB) can effectively protect privacy while sacrificing only slight reasoning performance.

The functional units and modules of the processor and methods in accordance with the embodiments disclosed herein may be embodied in hardware or software. That is, the claimed processor may be implemented entirely as machine instructions or as a combination of machine instructions and hardware elements. Hardware elements include, but are not limited to, computing devices, computer processors, or electronic circuitries including but not limited to application specific integrated circuits (ASIC), field programmable gate arrays (FPGA), microcontrollers, and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

The system may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

The system may also be configured as distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

1. A system using a privacy-preserving neural graph database for receiving a query from a user and giving an answer to the user in response to the query, comprising:
a user query input receiver for serving as a user interface to receive a structured query language as a query from a user;
a graph builder module configured to receive the query from the user query input receiver and configured to construct a computational graph for converting the query into a directed acyclic graph, where edges represent operations on sets of entities and attributes;
a query encoder model configured to receive a query graph related to the computational graph from the graph builder module for processing the query graph, wherein the query encoder model is configured to convert the query graph into a vector format;
an answer retrieval module configured to receive the vector format of the query graph from the query encoder model and retrieve candidate answer sets, wherein information output by the answer retrieval module denotes answer sets of entities or values retrieved by the computational graph;
a privacy risk identifier configured to receive the information output by the answer retrieval module and determine whether the answer sets pose any privacy risks, check for sensitive information, and flag queries that lead to privacy breaches, wherein the privacy risk identifier is further configured to classify the answer sets from the computational graph into a public answer set and a privacy answer set;
a score calculator engine configured to receive the public answer set and the privacy answer set and calculate a score of each candidate answer by computing probability of the public answer set and the privacy answer set using corresponding loss functions, wherein a low threshold is assigned to a loss function for the public answer set by the score calculator engine, requiring a loss function calculation result for the public answer set to be lower than the threshold, and wherein a high threshold is given to a loss function for the privacy answer set by the score calculator engine, requiring a loss function calculation result for the privacy answer set to be higher than the threshold; and
an answer output module configured to reference results of the loss functions in combination with the threshold values to select a final answer for the original query.

2. The system according claim 1, wherein the query encoder model is further configured to provide an encoding process for transforming the query into a vector representation or a numerical representation.

3. The system according claim 1, wherein the answer retrieval module comprises a projection engine and an operator setting model for the computational graph.

4. The system according claim 3, wherein the projection engine is configured to perform various types of projection operations, comprising attribute projection and relation projection.

5. The system according claim 4, wherein the projection engine is configured to perform various types of projection operations, comprising attribute projection and relation projection and involving extracting relevant entities or numerical values from the entity set and processing them according to specified relationships and attribute types.

6. The system according claim 5, wherein the operator setting model is configured to handle set operations comprising intersections and unions.

7. The system according claim 6, wherein the operator setting model provides an intersection operator on multiple sets of entities or numerical values to identify common elements shared among all sets, and wherein the operator setting model provides a union operator on multiple sets of entities or numerical values to identify all elements across all sets.

8. The system according claim 7, wherein the privacy risk identifier comprises a includes a privacy threatening answers classification model that collaborates in classifying the answer sets from the computational graph into the public answer set and the privacy answer set, based on whether the answer sets have to be inferred under involvement of private information.

9. The system according claim 8, wherein, when a projection operation result provided by the projection engine involves private attributes, the resulting answers are marked as privacy answers by the privacy risk identifier using the privacy threatening answers classification model, and wherein results of intersection operations provided by the operator setting model are considered privacy answers by the privacy risk identifier using the privacy threatening answers classification model if they belong to the privacy answer set, even when derived from multiple answer sets, and wherein, for union operation results provided by the operator setting model, the results are considered privacy answers if they include elements belonging to the privacy answer set while not belonging to public answer sets.

10. The system according claim 8, wherein the privacy risk identifier further comprises a privacy evaluator model configured to evaluate whether the privacy answer set contains any privacy answer with lower privacy risk.

11. The system according claim 1, wherein the answer output module is configured to pick the most suitable answer from the answer sets using algorithms, AI models, or machine learning models.

12. The system according claim 11, wherein the algorithms, AI models, or machine learning models are well-trained, and wherein adversarial techniques are introduced during a training stage to generate indistinguishable or obfuscated answers when queried with private information, thereby making it more difficult to infer privacy through complex private queries while still accurately retrieving non-private answers.

13. A method using a privacy-preserving neural graph database for receiving a query from a user and giving an answer to the user in response to the query, comprising:
receiving, by a user query input receiver, a structured query language as a query from a user;
constructing, by a graph builder module, a computational graph for converting the query into a directed acyclic graph, where edges represent operations on sets of entities and attributes;
encoding, by a query encoder model, the query graph related to the computational graph into a vector format;
retrieving, by an answer retrieval module, the vector format of the query graph into candidate answer sets, wherein information output by the answer retrieval module denotes answer sets of entities or values retrieved by the computational graph;
determining, by a privacy risk identifier, whether the answer sets pose any privacy risks, check for sensitive information, and flag queries that lead to privacy breaches;
classifying, by the privacy risk identifier, the answer sets from the computational graph into a public answer set and a privacy answer set;
calculating, by a score calculator engine, a score of each candidate answer by computing probability of the public answer set and the privacy answer set using corresponding loss functions, wherein a low threshold is assigned to a loss function for the public answer set by the score calculator engine, requiring a loss function calculation result for the public answer set to be lower than the threshold, and wherein a high threshold is given to a loss function for the privacy answer set by the score calculator engine, requiring a loss function calculation result for the privacy answer set to be higher than the threshold; and
referencing, by an answer output module, results of the loss functions in combination with the threshold values to select a final answer for the original query.

14. The method according claim 13, wherein the answer output module is configured to pick the most suitable answer from the answer sets using algorithms, AI models, or machine learning models.

15. The method according claim 14, wherein the algorithms, AI models, or machine learning models are well-trained, and wherein adversarial techniques are introduced during a training stage to generate indistinguishable or obfuscated answers when queried with private information, thereby making it more difficult to infer privacy through complex private queries while still accurately retrieving non-private answers.
